(19) United States
(12) Patent Application Publication
(10) Pub. No.: US 2009/0239115 A1
(43) Pub. Date: Sep. 24, 2009

(54) HETEROATOM-CONTAINING MESOPOROUS CARBON, METHOD OF PREPARING THE SAME, AND FUEL CELL USING THE HETEROATOM-CONTAINING MESOPOROUS CARBON

(75) Inventors: Chan-ho Pak, Seoul (KR); Hyuk Chang, Seongnam-si (KR); Ji-man Kim, Suwon-si (KR); Hyung-Ik Lee, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/258,828

(22) Filed: Oct. 27, 2008

(30) Foreign Application Priority Data
Mar. 20, 2008 (KR) 2008-25912

(51) Int. Cl. H01M 8/10; B32B 9/00

(52) U.S. Cl. 429/30; 428/220

(57) ABSTRACT

A heteroatom-containing mesoporous carbon has a pore diameter of 11 to 35 nm, has a specific surface area of 500 m²/g or more, and comprises a heteroatom. The heteroatom-containing mesoporous carbon is formed by a method including mixing a carbon precursor, a heteroatom-containing precursor, and silica particles to prepare a carbon precursor mixture; drying and carbonizing the carbon precursor mixture to prepare a silica-carbon composite; and removing silica from the silica-carbon composite. An anode and/or a cathode of fuel cell includes catalyst particles supported on the heteroatom-containing mesoporous carbon.

### CROSS-REFERENCE TO RELATED PATENT APPLICATION

This application claims the benefit of Korean Patent Application No. 2008-25912, filed on Mar. 20, 2008, in the Korean Intellectual Property Office, the disclosure of which is incorporated herein in its entirety by reference.

### BACKGROUND OF THE INVENTION

1. Field of the Invention

Aspects of the present invention relate to a heteroatom-containing mesoporous carbon, a method of preparing the same, and a fuel cell using the heteroatom-containing mesoporous carbon.

2. Description of the Related Art

Conventional carbons having pores are referred to as activated carbons. Activated carbons are prepared by physically or chemically activating raw materials such as woods, peats, charcoals, coals, brown coals, coconut palm peels, petroleum corks, or the like. However, such activated carbons have a pore diameter of 1 nm or less and have poor connectivity between pores. Thus, to fundamentally overcome various limits of activated carbons prepared by general activation, methods of preparing mesoporous carbon materials have been developed. In these methods, mesoporous carbon materials are synthesized using a template.

According to the synthesis method using a template, a material comprising an inorganic compound such as silica, alumina, or the like is used as a template, and the template is mixed with a polymer that can be used as a carbon precursor to prepare a template-polymer composite. Then, the composite is heat treated for carbonization and only the inorganic template is selectively removed to generate the pores. As a result, a desired mesoporous carbon can be obtained. Two methods among various synthesis methods are particularly notable. One is a method in which a mesoporous silica material is impregnated with a phenol resin or sucrose in a gaseous or aqueous state, and then heat-treated to obtain a carbon-silica composite, after which the silica material is removed from the composite to obtain a desired mesoporous carbon. The other is a method in which an aqueous silica sol and a carbon precursor are combined to obtain a carbon precursor-silica sol mixture, the mixture is heat treated to obtain a carbon-silica composite, and then the silica material is removed therefrom to obtain a desired mesoporous carbon.

According to the former method, pores of the mesoporous carbon are connected tri-dimensionally, and thus the mesoporous carbon exhibits excellent physical properties. However, many process operations are used to synthesize the mesoporous carbon and accordingly, the manufacturing costs of the mesoporous carbon are very high. Thus, it is disadvantageous to use the mesoporous carbon for industrial applications.

According to the latter method, the manufacturing costs are low as compared with those of the former method. However, it is difficult to control pore sizes of the finally obtained mesoporous carbon. Therefore, there is still need for improvement in providing mesoporous carbon.

### SUMMARY OF THE INVENTION

Aspects of the present invention provide a heteroatom-containing mesoporous carbon, the pore sizes of which can be easily adjusted, a method of preparing the heteroatom-containing mesoporous carbon, and a fuel cell using the heteroatom-containing mesoporous carbon.

According to an embodiment of the present invention, there is provided a heteroatom-containing mesoporous carbon that has a pore diameter of 11 to 35 nm, has a specific surface area of 500 m²/g or more, and comprises a heteroatom.

According to another embodiment of the present invention, there is provided a method of preparing a heteroatom-containing mesoporous carbon, the method comprising; mixing a carbon precursor, a heteroatom-containing precursor, and silica particles to prepare a carbon precursor mixture; drying and carbonizing the carbon precursor mixture to prepare a silica-carbon composite; and removing silica from the silica-carbon composite.

According to another embodiment of the present invention, there is provided a fuel cell comprising a cathode, an anode, and an electrolyte membrane disposed between the cathode and the anode, wherein at least one of the cathode and anode comprises the heteroatom-containing mesoporous carbon and metal catalyst particles supported on the heteroatom-containing mesoporous carbon.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating a method of preparing a heteroatom-containing mesoporous carbon, according to an embodiment of the present invention, wherein pore sizes of the mesoporous carbon are adjusted according to the addition of heteroatoms, wherein the reference character (a) refers to a carbonization process in a nitrogen atmosphere, and reference character (b) refers to a stirring process using an aqueous solution of hydrofluoric acid and a process of selectively removing silica by filtration;

FIG. 2 is a graph showing nitrogen adsorption isotherms of the heteroatom-containing mesoporous carbons prepared in Examples 1 through 4 and Comparative Example 1;

FIG. 3 is a graph showing nitrogen adsorption isotherms of the heteroatom-containing mesoporous carbons prepared in Example 5 and Comparative Example 2; and

FIG. 4 is a graph showing infrared spectroscopy (IR) spectra of samples obtained by carbonizing each of the heteroatom-containing mesoporous carbons of Example 5 and Comparative Example 2, and then sintering each heteroatom-containing mesoporous carbon at 550° C. in an air atmosphere to remove carbon.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide a method of preparing a heteroatom-containing mesoporous carbon, in which when the heteroatom-containing mesoporous carbon is synthesized using silica colloidal nanoparticles as a template, pore sizes of the heteroatom-containing mesoporous carbon can easily be adjusted finely and controlled variously, instead of separately adjusting the size of the silica colloidal nanoparticles as a starting material.

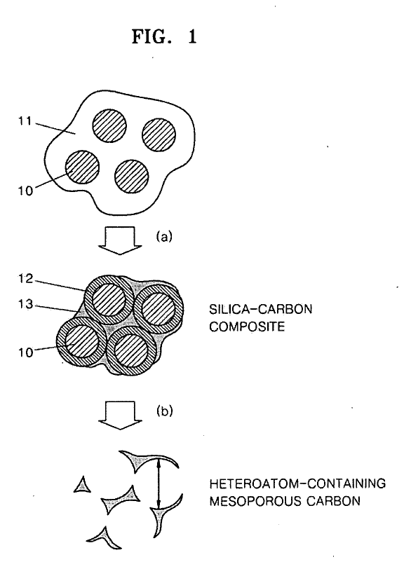

FIG. 1 is a schematic diagram illustrating a method of preparing a heteroatom-containing mesoporous carbon, according to an embodiment of the present invention, wherein pore sizes of the heteroatom-containing mesoporous carbon are adjusted according to the addition of heteroatoms.

Referring to FIG. 1, according to the current embodiment of the present invention, silica nanoparticles 10, a carbon precursor, a heteroatom-containing carbon precursor, acid, and a solvent are mixed, and then a mixture 11 of the carbon precursor and the heteroatom-containing carbon precursor reacts (operation (a)) to form a nano-coating layer 12 formed of a heteroatom oxide on a surface of the silica nanoparticles 10. Here, the silica nanoparticles 10 are used in a colloidal nanoparticle state.

As a result, a silica-carbon composite formed of carbon 13 and silica nanoparticles 10, which is surface-coated by the nano-coating layer 12 formed of the heteroatom oxide, is formed. Then, the silica nanoparticles 10 are removed from the silica-carbon composite (operation (b)) to obtain a heteroatom-containing mesoporous carbon, the pore sizes of which can easily be adjusted and fine-tuned. According to the current embodiment of the present invention, the pore sizes of the heteroatom-containing mesoporous carbon may be relatively large as illustrated in FIG. 1.

The heteroatom oxide may be an oxide of at least one heteroatom selected from the group consisting of boron (B), phosphorous (P), manganese (Mn), zinc (Zn), nickel (Ni), arsenic (As), aluminum (Al), vanadium (V), gallium (Ga), and sulfur (S).

The presence of the nano-coating layer 12 formed of the heteroatom oxide, which is coated on the surface of the silica nanoparticles 10, can be confirmed by infrared spectroscopy (IR) analysis of the composite before the silica is removed and by measuring the porosity of the consequently prepared carbon.

Hereinafter, the method of preparing a heteroatom-containing mesoporous carbon, according to aspects of the present invention, will be described in greater detail.

First, a carbon precursor, a heteroatom-containing precursor, and silica particles are mixed to prepare a carbon precursor mixture.

Examples of the carbon precursor include carbohydrates such as sucrose, furfuryl alcohol, divinylbenzene, resorcinol-formaldehyde, acrylonitrile, a para-toluenesulfonic acid, and aromatic compounds such as phenanthrene and anthracene. These materials may be used alone or in a combination of at least two of the materials.

The amount of the carbon precursor may be in a range of 5 to 40 parts by weight based on 100 parts by weight of the carbon precursor mixture. If the amount of the carbon precursor is less than 5 parts by weight based on 100 parts by weight of the carbon precursor mixture, the mesoporous carbon may not be satisfactorily formed. If the amount of the carbon precursor is greater than 40 parts by weight based on 100 parts by weight of the carbon precursor mixture, the carbon precursor may not completely dissolve in a solvent. Thus, it may be difficult to form the carbon precursor mixture, and agglomeration between particles worsens, resulting in a decrease in the surface area of the mesoporous carbon.

In addition, to dissolve and uniformly disperse the carbon precursor, at least one of acid and a solvent may be used.

The acid may be an organic acid or an inorganic acid. For example, the acid may be a sulfuric acid, a nitric acid, a phosphoric acid, or a para-toluene sulfuric acid.

The amount of the acid may be in a range of 5 to 400 parts by weight based on 100 parts by weight of the carbon precursor. If the amount of the acid is less than 5 parts by weight based on 100 parts by weight of the carbon precursor, the effect of facilitating the formation of a nano-coating layer on the surface of the silica nanoparticles may be insignificant. On the other hand, if the amount of the acid is greater than 400 parts by weight based on 100 parts by weight of the carbon precursor, the porosity of the mesoporous carbon may deteriorate.

The solvent may be any solvent that can uniformly disperse the carbon precursor. Examples of the solvent include water, acetone, methanol, ethanol, isopropylalcohol, n-propylalcohol, butanol, dimethylacetamide, dimethylformamide, dimethylsulfoxide, N-methyl-2-pyrrolidone, tetrahydrofurane, tetrabutylacetate, n-butylacetate, m-cresol, toluene, ethylene glycol, γ-butyrolactone, hexafluoroisopropanol (HFIP), and the like. These materials can be used alone or in a combination of at least two of the materials.

The amount of the solvent may be in a range of 100 to 500 parts by weight based on 100 parts by weight of the carbon precursor. If the amount of the solvent is less than 100 parts by weight based on 100 parts by weight of the carbon precursor, the carbon precursor may not fully dissolve in the solvent. If the amount of the solvent is greater than 500 parts by weight based on 100 parts by weight of the carbon precursor, agglomeration between particles may worsen.

The heteroatom-containing precursor may be any precursor that contains a heteroatom. As non-limiting examples, the heteroatom-containing precursor may comprise one or more selected from the group consisting of B, P, Mn, Zn, Ni, As, Al, V, and Ga. As more specific, non-limiting examples, the heteroatom-containing precursor may comprise one of more selected from the group consisting of H₃BO₃, HBO₂, H₂B₄O₇, B₁₉H₁₄, Na₂B₄O₇, NaBO₃.H₂O, NaBO₂.H₂O, BPO₄.H₂O, phosphoric acid, manganese acetate, zinc chloride, nickel chloride, arsenic chloride, sodium aluminate, vanadium chloride, and gallium chloride.

The amount of the heteroatom-containing precursor may be in a range of 10 to 1000 parts by weight based on 100 parts by weight of the carbon precursor. If the amount of the heteroatom-containing precursor is less than 10 parts by weight based on 100 parts by weight of the carbon precursor, the effect of the addition of the heteroatom-containing precursor for adjustment of pore sizes of the mesoporous carbon may be insignificant. If the amount of the heteroatom-containing precursor is greater than 1000 parts by weight based on 100 parts by weight of the carbon precursor, a mesoporous carbon having a desired structure may not be formed.

The amount of the silica particles of the carbon precursor mixture may be in a range of 30 to 50 parts by weight based on 100 parts by weight of the carbon precursor mixture. Silica particles that contain silica and have an average particle diameter of 4 to 20 nm may be used.

If the amount of the silica particles is less than 30 parts by weight based on 100 parts by weight of the carbon precursor mixture, agglomeration between particles may worsen during the formation of the nano-coating layer formed of an oxide of the heteroatom, and thus the surface area of the mesoporous carbon may decrease. If the amount of the silica particles is greater than 50 parts by weight based on 100 parts by weight of the carbon precursor mixture, a relative amount of the carbon precursor is small, and thus the nano-coating layer may not be formed smoothly.

The silica nanoparticles may be added directly in the form of nanoparticles or may be added in a silica sol solution state with the silica nanoparticles therein. Taking into account the dispersibility with other constituents when the carbon precursor mixture is prepared, the silica nanoparticles may be added in a silica sol solution state with the silica nanoparticles therein.

The amount of the silica nanoparticles may be in a range of 10 to 90 parts by weight based on 100 parts by weight of the silica sol solution. The average particle diameter of the silica nanoparticles included in the silica sol solution may be in a range of 4 to 20 nm. The remaining constituents included in the silica sol solution besides the silica nanoparticles, are water as a solvent and a stabilizer dissolved therein (NaOH or ammonia).

According to an embodiment of the present invention, the silica sol solution including the silica particles may be LUDOX HS-40 (DuPont) (aqueous colloidal silica in which the amount of silica particles is about 40 wt % and the average particle diameter thereof is 12 nm) (obtained from Aldrich).

Next, the carbon precursor mixture is dried and carbonized to obtain a silica-carbon composite. The drying temperature is not particularly limited, and may be, for example, in a range of 70 to 100° C. In addition, the drying process may be performed under a reduced pressure for rapid drying.

In addition, the silica-carbon composite is structured such that the carbon precursor that forms a layer on the surface of the silica particles functioning as a template is graphitized by carbonization.

The carbonization is performed by heat treating the silica-carbon composite using a heater such as an electric furnace or the like at a carbonization temperature ranging from 700 to 1200° C. If the carbonization temperature is less than 700° C., the graphitization may not be completely performed, and thus the structure of the silica-carbon composite may be incomplete. If the carbonization temperature is greater than 1200° C., the carbon composite may thermally decompose or the structure of the silica particles functioning as a template may be modified.

The carbonization may be performed under a non-oxidizing atmosphere such as a vacuum atmosphere, a nitrogen atmosphere, or an inert gas atmosphere.

Next, silica is removed from the silica-carbon composite.

The removing of the silica may be performed using a solvent that can selectively dissolve the silica, such as, for example, hydrofluoric acid (HF), sodium hydroxide (NaOH), potassium hydroxide (KOH), or an aqueous solution thereof.

The concentration of an aqueous solution used as the solvent to selectively dissolve the silica may be in a range of 5 to 47 wt %, and the concentration of an aqueous sodium hydroxide solution used as the solvent to selectively dissolve the silica may be in a range of 5 to 30 wt %.

It is known that in a silica removal process, silica becomes a soluble silicate by alkali fusion, carbonate melting, or the like, and reacts with HF to form SiF₄, which is easily corroded. As described above, by removing the silica, pores of the heteroatom-containing mesoporous carbon can be formed.

The pores of the heteroatom-containing mesoporous carbon according to aspects of the present invention may have a diameter of 11 to 35 nm, or more specifically, 13 to 35 nm. The specific surface area of the heteroatom-containing mesoporous carbon of the present invention may be in a range of 500 m²/g or more, and in particular, the Brunauer-Emmett-Teller (BET) specific surface area thereof may be in a range of 500 to 900 m²/g.

If the specific surface area of the heteroatom-containing mesoporous carbon is less than 500 m²/g, it may be difficult to increase the dispersion degree of supported metallic particles. In addition, if the average diameter of the pores of the heteroatom-containing mesoporous carbon is less than 11 nm, materials may not be easily diffused when the heteroatom-containing mesoporous carbon is applied as a catalyst carrier or an electrode. If the average diameter of the pores of the heteroatom-containing mesoporous carbon is greater than 35 nm, the material diffusion can be easily performed, but there is high possibility of a decrease in the surface area of the heteroatom-containing mesoporous carbon, and thus, the function of the material as the catalyst carrier may be reduced.

The amount of the heteroatoms may be in a range of 0.01 to 10 parts by weight, or more specifically, in a range of 0.1 to 5 parts by weight based on 100 parts by weight of the heteroatom-containing mesoporous carbon. If the amount of the heteroatoms is less than 0.01 parts by weight based on 100 parts by weight of the heteroatom-containing mesoporous carbon, the effect of expansion of carbon pores may be insignificant. If the amount of the heteroatoms is greater than 10 parts by weight based on 100 parts by weight of the heteroatom-containing mesoporous carbon, uniform porosity may not be maintained, and the effect of expansion of carbon pores according to an increase in the amount of the heteroatoms may also be insignificant.

According to aspects of the present invention, the nano-coating layer formed of the heteroatom oxide is formed on the surface of the silica nanoparticles to synthesize the heteroatom-containing mesoporous carbon, the pore sizes of which can be adjusted. Thus, the excellent effect of adjusting the pore sizes of the heteroatom-containing mesoporous carbon instead of adjusting the size of the silica nanoparticles can be obtained.

In addition, the heteroatom-containing mesoporous carbon, which is prepared using the manufacturing method according to aspects of the present invention as described above, can be obtained in various forms, such as in powder, as a monolith, or the like, and thus can have a wide range of applications. In particular, the heteroatom-containing mesoporous carbon can be used as a catalyst support, and thus can be applied in portable devices such as notebook computers, mobile phones, and the like, movable devices such as vehicles, buses, and the like, and fuel cells for home use.

A supported catalyst that uses the heteroatom-containing mesoporous carbon prepared as described above as a catalyst support will now be described, according to an embodiment of the present invention.

The supported catalyst according to aspects of the present invention comprises the heteroatom-containing mesoporous carbon as described above and metal catalyst particles that are dispersed and supported in the heteroatom-containing mesoporous carbon. The metal catalyst particles are dispersed on the surface of the heteroatom-containing mesoporous carbon and in the pores of the heteroatom-containing mesoporous carbon.

The metal catalyst that can be used in the supported catalyst according to aspects of the present invention is not particularly limited. For example, the metal catalyst can be one selected from the group consisting of Ti, V, Cr, Mn, Fe, Co, Ni, Cu, Zn, Al, Mo, Se, Sn, Pt, Ru, Pd, W, Ir, Os, Rh, Nb, Ta, Pb, and Bi, and mixtures thereof. As specific, non-limiting examples, the metal catalyst may be platinum, an alloy of platinum and ruthenium, or the like, which have an excellent affinity with the heteroatom-containing mesoporous carbon.

The metal catalyst may be appropriately selected according to a specific reaction in which the supported catalyst is to be applied. The metal catalyst may be a single metal or may be an alloy of at least two metals.

For example, when the supported catalyst according to aspects of the present invention is used in a catalyst layer of a cathode or anode for a fuel cell, platinum may be used as the metal catalyst. As another example, when the supported catalyst is used in a catalyst layer of an anode for a direct methanol fuel cell, an alloy of platinum and ruthenium may be used as the metal catalyst. In this case, the atomic ratio of platinum to ruthenium may be generally in a range of about 0.5:1 to about 2:1. As another example, when the supported catalyst is used in a catalyst layer of a cathode for a direct methanol fuel cell, platinum may be used as the metal catalyst.

The average particle diameter of the metal catalyst particles may be in a range of about 1 nm to about 5 nm. If the average particle diameter of the metal catalyst particles is less than 1 nm, the catalyst particles may be buried in a carbon backbone, and thus reactants may not be able to approach the catalyst particles, resulting in a very low possibility that the catalyst particles can facilitate a reaction. If the average particle diameter of the metal catalyst particles is greater than 5 nm, the total reaction surface area of the catalyst particles is decreased, and thus, the activity of the catalyst is reduced.

The amount of the metal catalyst particles of the supported catalyst may be in a range of 20 to 90 parts by weight based on 100 parts by weight of the total weight of the supported catalyst. If the amount of the metal catalyst particles of the supported catalyst is less than 20 parts by weight based on 100 parts by weight of the total weight of the supported catalyst, there may be an insufficient amount of catalyst to be effective in a fuel cell. If the amount of the metal catalyst particles of the supported catalyst is greater than 20 parts by weight based on 100 parts by weight of the total weight of the supported catalyst, costs increase, and the size of the catalyst particles may be increased.

In the supported catalyst according to aspects of the present invention, when the metal catalyst particles are heat treated, an increase ratio of the average particle diameter of the metal catalyst particles after the heat treatment to the average particle diameter of the metal catalyst particles before the heat treatment is in a range of 20% or less, and in particular, in a range of 10 to 20%, which is a very low increase ratio. As such, the growth of the size of the metal catalyst particles owing to a high-temperature heat treatment process is inhibited.

The heat treatment may be performed at a temperature ranging from 140 to 160° C.

The supported catalyst according to aspects of the present invention may be prepared using various known methods of preparing a supported catalyst. For example, the supported catalyst may be prepared by impregnating a support with a catalytic metal precursor solution, and then reducing the catalytic metal precursor. These methods are disclosed in detail in a variety of publications, and thus further descriptions thereof are not necessary herein.

Hereinafter, a fuel cell according to aspects of the present invention will be described in more detail.

Aspects of the present invention also provide a fuel cell including a cathode, an anode, and an electrolyte membrane disposed between the cathode and the anode, wherein at least one of the cathode and the anode comprises the supported catalyst according to aspects of the present invention using the heteroatom-containing mesoporous carbon. The fuel cell according to aspects of the present invention includes the supported catalyst described above, and thus, the growth of catalyst particles is inhibited and the activity of the catalyst is satisfactorily maintained even over a long operating period or during a high-temperature operation.

The fuel cell according to aspects of the present invention may be a phosphoric acid fuel cell (PAFC), a proton exchange membrane fuel cell (PEMFC), or a direct methanol fuel cells (DMFC), as non-limiting examples. The structures and manufacturing methods of these fuel cells are not particularly limited, and specific examples thereof are disclosed in detail in a variety of publications. Thus, further descriptions thereof are not necessary herein.

When the supported catalyst using the heteroatom-containing mesoporous carbon according to aspects of the present invention, wherein the heteroatom is S for example, is applied in a fuel cell, problems of conventional fuel cells, such that due to agglomeration of catalyst particles, the size of the catalyst particles is increased, thereby reducing the activity area of the catalyst, can be addressed in spite of a long operating period. Therefore, when the supported catalyst according to aspects of the present invention is used, a fuel cell with improved performances such as efficiency can be manufactured.

Aspects of the present invention will be described in further detail with reference to the following examples. These examples are for illustrative purposes only and are not intended to limit the scope of the present invention.

### EXAMPLE 1

### Preparation of Boron-Containing Mesoporous Carbon

6.25 g of sucrose (manufactured by Aldrich) was added to a solution prepared by mixing 0.705 g of sulfuric acid and 100 ml of distilled water. Then, the mixture was dissolved by stirring for about 10 minutes until the mixture was completely transparent.

5.65 g of a boric acid (H₃BO₃) was added to the resulting sucrose solution, and then the mixture was dissolved by stirring until the mixture was transparent. Then, 13.72 g of LUDOX HS-40 (amount of SiO₂: 40 wt %) was added to the mixture, and fully mixed by stirring for 1 minute to prepare a carbon precursor mixture.

The prepared carbon precursor mixture was added to a 500 ml beaker and then left to sit for 3 hours in an oven at 80° C. to be dried. Then, the resultant was heat treated for another 3 hours in an oven at 160° C. A formed solid was collected from the beaker and placed in a furnace. The temperature of the furnace was increased to 900° C. at a rate of 3° C. per minute in a nitrogen atmosphere, and then the formed solid was maintained at the above temperature for 3 hours to be carbonized. As a result, a silica-carbon composite was obtained.

The prepared silica-carbon composite was added to 200 ml of a 20 wt % aqueous solution of hydrofluoric acid, and stirred for 10 minutes or more. Then the resultant was filtered twice to remove silica. As a result, a boron-containing mesoporous carbon was prepared.

### EXAMPLE 2

### Preparation of Boron-Containing Mesoporous Carbon

A boron-containing mesoporous carbon was prepared in the same manner as in Example 1, except that 1.7 g of a boric acid was used.

### EXAMPLE 3

### Preparation of Boron-Containing Mesoporous Carbon

A boron-containing mesoporous carbon was prepared in the same manner as in Example 1, except that 16.9 g of a boric acid was used.

### EXAMPLE 4

### Preparation of Boron-Containing Mesoporous Carbon

A boron-containing mesoporous carbon was prepared in the same manner as in Example 1, except that 56.5 g of a boric acid was used.

### EXAMPLE 5

### Preparation of Boron-Containing Mesoporous Carbon

A boron-containing mesoporous carbon was prepared in the same manner as in Example 1, except that a silica colloid particle having an average particle diameter of about 20 nm was used instead of LODOX HS-40.

### COMPARATIVE EXAMPLE 1

### Preparation of Mesoporous Carbon

A mesoporous carbon was prepared in the same manner as in Example 1, except that boric acid was not used during the preparation of the carbon precursor mixture.

### COMPARATIVE EXAMPLE 2

### Preparation of Mesoporous Carbon

A mesoporous carbon was prepared in the same manner as in Example 5, except that boric acid was not used during the preparation of the carbon precursor mixture.

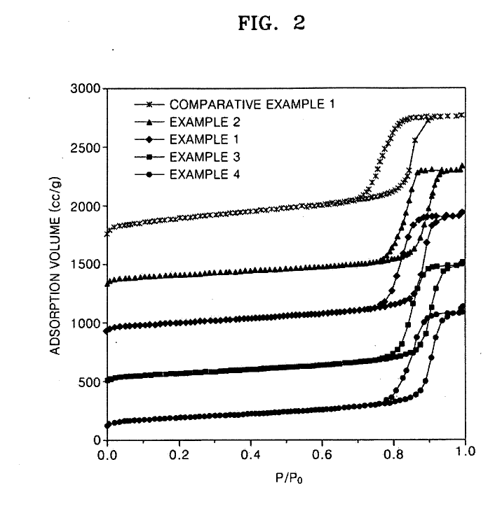

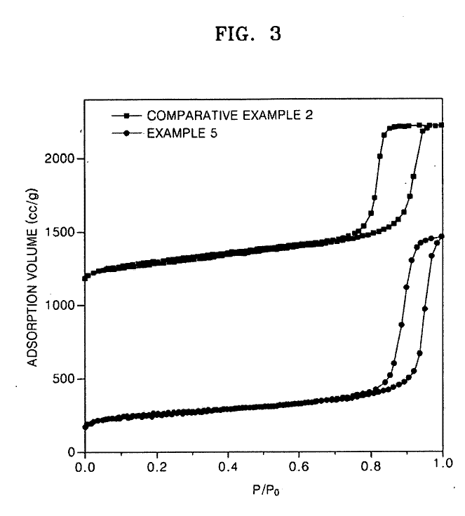

The surface area, pore volume and pore diameter of each of the mesoporous carbons prepared in Examples 1 through 5 and Comparative Examples 1 and 2 were measured. The results are shown in Table 1 below. Nitrogen adsorption isotherms of the mesoporous carbons prepared in Examples 1 through 5 and Comparative Examples 1 and 2 are illustrated in FIGS. 2 and 3.

TABLE 1

| | Surface area | Pore volume | Pore diameter |
|---|---|---|---|
| | (m²/g) | (cc/g) | (nm) |
| Example 1 | 723 | 1.75 | 19.0 |
| Example 2 | 740 | 1.80 | 16.0 |
| Example 3 | 576 | 1.71 | 21.0 |
| Example 4 | 663 | 1.74 | 21.5 |
| Example 5 | 892 | 2.25 | 35.0 |
| Comparative | 1013 | 1.30 | 13.8 |
| Example 1 | | | |
| Comparative | 1030 | 1.96 | 23.5 |
| Example 2 | | | |

As shown in Table 1, as compared with the mesoporous carbon of Comparative Example 1, the mesoporous carbons of Examples 1 through 5 had increased pore volume and pore diameter, thus having improved catalyst supporting capability.

Referring to FIG. 2, as shown in Table 1, in the case of Examples 1 through 4, the size of mesopores of the mesoporous carbon was continuously expanded and pore volume properties due to mesoporosity were improved, as compared with the case of Comparative Example 1. In addition, referring to FIG. 3 and Table 1, in the case of Example 5, the size of mesopores of the mesoporous carbon was expanded and pore volume properties due to mesoporosity were improved, as compared with the case of Comparative Example 2.

In addition, the mesoporous carbons of Examples 1 and 2 were analyzed using a transmission electron microscope (TEM). The TEM results showed that the mesoporous carbons of Examples 1 and 2 had a pore size suitable for use as a carrier of a supported catalyst.

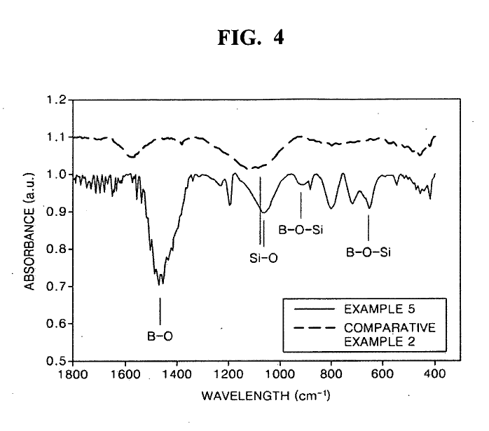

Infrared spectroscopy (IR) analysis was performed on samples obtained by carbonizing each of the mesoporous carbons of Example 5 and Comparative Example 2, and then sintering each mesoporous carbon at 550° C. in an air atmosphere to remove carbon. The IR spectrum results are illustrated in FIG. 4.

Referring to FIG. 4, it can be seen that a boric acid and silica colloidal particles react with each other during carbonization to form a boron oxide (B—O) and boron-silicon-oxide (B—O—Si). From these results, it is reasonable to conclude that a layer of a boric oxide and boron-silicon-oxide is formed on the surface of the silica colloidal particles due to the addition of a boric acid, and the silica colloidal particles having the layer are removed using hydrofluoric acid to expand pores of the prepared mesoporous carbon, according to the mechanism illustrated in FIG. 1.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A heteroatom-containing mesoporous carbon that has a pore diameter of 11 to 35 nm, has a specific surface area of 500 m²/g or more, and comprises a heteroatom.

2. The heteroatom-containing mesoporous carbon of claim 1, wherein the heteroatom comprises at least one selected from the group consisting of boron (B), phosphorous (P), manganese (Mn), zinc (Zn), nickel (Ni), arsenic (As), aluminum (Al), vanadium (V), gallium (Ga), and sulfur (S).

3. The heteroatom-containing mesoporous carbon of claim 1, wherein the amount of the heteroatom is in a range of 0.01 to 10 parts by weight based on 100 parts by weight of the heteroatom-containing mesoporous carbon.

4. A method of preparing a heteroatom-containing mesoporous carbon, the method comprising;
mixing a carbon precursor, a heteroatom-containing precursor, and silica particles to prepare a carbon precursor mixture;
drying and carbonizing the carbon precursor mixture to prepare a silica-carbon composite; and
removing silica from the silica-carbon composite.

5. The method of claim 4, wherein the heteroatom-containing precursor comprises at least one selected from the group consisting of H₃BO₃, HBO₂, H₂B₄O₇, B₁₉H₁₄, Na₂B₄O₇, NaBO₃.H₂O, NaBO₂.H₂O, BPO₄.H₂O, phosphoric acid, manganese acetate, zinc chloride, nickel chloride, arsenic chloride, sodium aluminate, vanadium chloride, and gallium chloride.

6. The method of claim 4, wherein the carbon precursor comprises at least one selected from the group consisting of a carbohydrate, furfuryl alcohol, divinylbenzene, resorcinol-formaldehyde, an acrylonitrile, a para-toluenesulfonic acid, phenanthrene, and anthracene.

7. The method of claim 4, wherein the amount of the heteroatom-containing precursor is in a range of 10 to 1000 parts by weight based on 100 parts by weight of the carbon precursor.

8. The method of claim 4, wherein silica nanoparticle in the silica-carbon composite is surface coated by a nano-coating layer formed of a heteroatom oxide.

9. The method of claim 8, wherein the heteroatom oxide is an oxide of at least one heteroatom selected from the group consisting of B, P, Mn, Zn, Ni, As, Al, V, Ga, and S.

10. The method of claim 4, wherein the amount of the silica particles is in a range of 30 to 50 parts by weight based on 100 parts by weight of the carbon precursor mixture.

11. The method of claim 4, wherein the silica particles are added as a silica sol solution state with silica nanoparticles therein.

12. The method of claim 11, wherein the amount of the silica nanoparticles is in a range of 10 to 90 parts by weight based on 100 parts by weight of the silica sol solution, and the average particle diameter of the silica nanoparticles of the silica sol solution is in a range of 4 to 20 nm.

13. The method of claim 4, wherein the drying is performed at a temperature in a range of 70 to 100° C.

14. The method of claim 4, wherein the carbonizing is performed at a temperature in a range of 700 to 1200° C.

15. The method of claim 4, wherein the removing of the silica is performed using hydrofluoric acid, sodium hydroxide, potassium hydroxide, or an aqueous solution thereof.

16. The method of claim 4, further comprising adding at least one of an acid and a solvent when the carbon precursor mixture is prepared.

17. The method of claim 16, wherein the acid comprises at least one selected from the group consisting of a sulfuric acid, a nitric acid, a phosphoric acid, and a para-toluene sulfuric acid.

18. The method of claim 16, wherein the solvent comprises at least one selected from the group consisting of water, acetone, methanol, ethanol, isopropylalcohol, n-propylalcohol, butanol, dimethylacetamide, dimethylformamide, dimethylsulfoxide, N-methyl-2-pyrrolidone, tetrahydrofurane, tetrabutylacetate, n-butylacetate, m-cresol, toluene, ethylene glycol, γ-butyrolactone, and hexafluoroisopropanol (HFIP).

19. A fuel cell comprising a cathode, an anode, and an electrolyte membrane disposed between the cathode and the anode, wherein at least one of the cathode and anode comprises a heteroatom-containing mesoporous carbon that has a pore diameter of 11 to 35 nm, has a specific surface area of 700 m²/g or more, and comprises a heteroatom, and metal catalyst particles supported in the heteroatom-containing mesoporous carbon.
